(19) United States
(12) Patent Application Publication
(10) Pub. No.: US 2010/0018638 A1
(43) Pub. Date: Jan. 28, 2010

(54) METHOD FOR MANUFACTURING FLEXIBLE PRINTED CIRCUIT BOARD

(75) Inventor: QI ZHANG, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: FUKUI PRECISION COMPONENT (SHENZHEN) CO., LTD., Shenzhen City (CN); FOXCONN ADVANCED TECHNOLOGY INC., Tayuan (TW)

(21) Appl. No.: 12/354,099

(22) Filed: Jan. 15, 2009

(30) Foreign Application Priority Data
Jul. 28, 2008 (CN) 200810303131.1

(51) Int. Cl. B29C 65/00

(52) U.S. Cl. 156/182

(57) ABSTRACT

A method for manufacturing a flexible printed circuit sheet (FPCB), comprising: providing a flexible copper clad laminate (FCCL), the FCCL comprising an insulating layer and a copper layer disposed thereon; providing a reinforcing sheet, the reinforcing sheet comprising a base and a binder layer attached thereon; attaching the FCCL onto the binder layer of the reinforcing sheet with the copper layer exposed; forming electrical traces in the copper layer, thus obtaining a FPCB substrate; and removing the FPCB substrate from the reinforcing sheet.

### BACKGROUND

1. Technical Field

The present disclosure generally relates to flexible printed circuit boards (FPCBs), and particularly relates to a method for manufacturing an FPCB using a rigid reinforcing sheet.

2. Discussion of Related Art

With the development of science and technology, microphones, portable computers and other electronic products have achieved ever greater levels of miniaturization, thereby requiring thinner FPCBs having a plurality of fine electrical traces.

During a process of manufacturing a single-layer FPCB, a photoresist layer is applied onto a flexible copper clad laminate (FCCL). Thereafter, the photoresist layer is exposed with a photomask having a predetermined pattern. After exposure, an unpolymerized portion of the photoresist layer is dissolved with a developing agent, and a region of the FCCL corresponding to the dissolved portion is removed using an etching process.

However, a thin FCCL easily wrinkles. As a result, the photoresist layer on the FCCL has different thicknesses in different areas. Accordingly, diameters of the formed electrical traces in different areas are not uniform.

Therefore, a method for manufacturing an FPCB is desired to overcome the above-described problems.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of embodiments. Moreover, in the drawings, like reference numerals designate corresponding parts throughout the different views.

FIG. 1 shows a flow chart of a method for manufacturing a flexible printed circuit board according to a first embodiment.

FIG. 2 is a cross-sectional view of a rigid reinforcing sheet and two FCCLs provided in the first embodiment.

FIG. 3 is similar to FIG. 2, but showing the two FCCLs are laminated onto the rigid reinforcing sheet.

FIG. 4 is similar to FIG. 3, but showing a photoresist layer is applied onto the FCCLs.

FIG. 5 is similar to FIG. 4, but showing the photoresist layer is exposed.

FIG. 6 is similar to FIG. 5, but showing portions of the photoresist layer are removed from FCCLs.

FIG. 7 is similar to FIG. 6, but showing portions of each FCCL are removed while the remaining portions are covered by the residual portion of the photoresist layer.

FIG. 8 is similar to FIG. 7, but showing the FPCBs having a plurality of electrical traces.

FIG. 9 is similar to FIG. 8, but showing the FPCBs are separated from the reinforcing sheet.

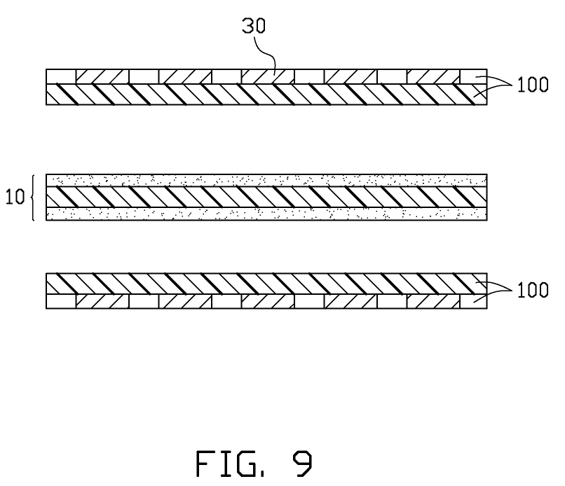

FIG. 10 shows a roll to roll process employed in a method for manufacturing an FPCB according to a second embodiment.

### DETAILED DESCRIPTION OF EMBODIMENTS

The method will be discussed in detail with the following exemplary embodiments.

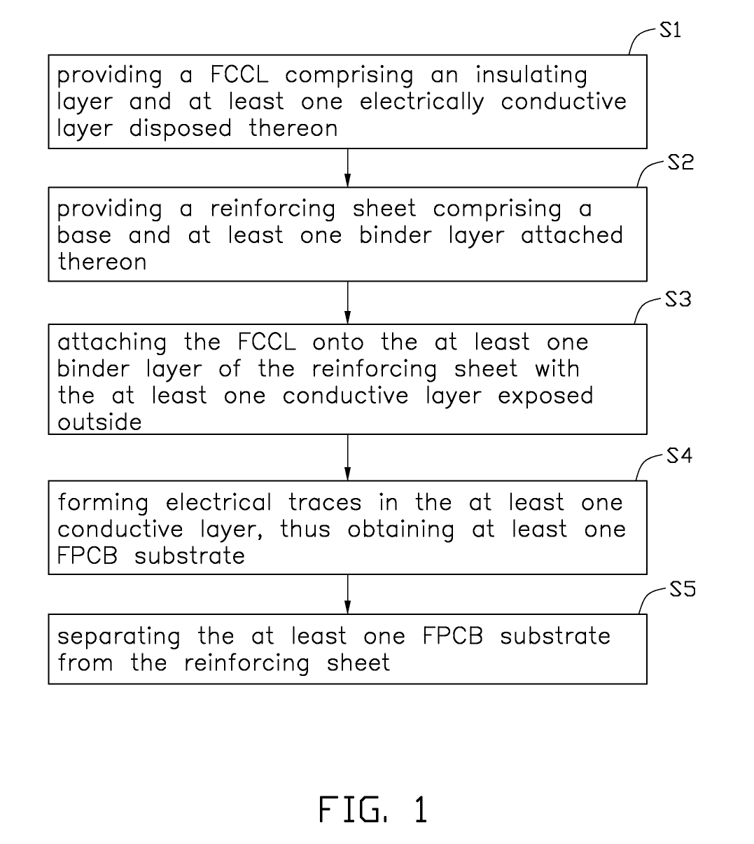

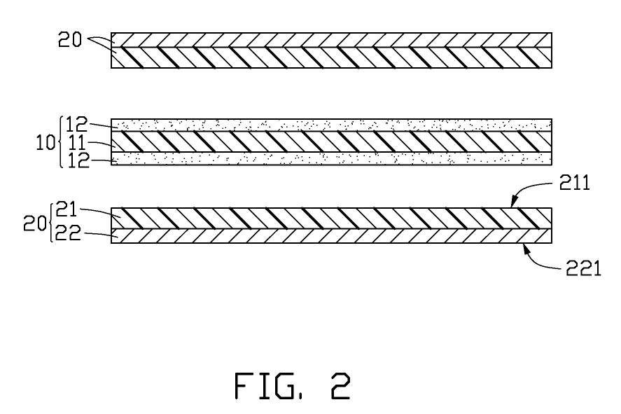

Referring to FIGS. 1, and 2, in step S1, two FCCLs 20 are provided in single sheet form, and in step S2, a rigid reinforcing sheet 10 is provided. The reinforcing sheet 10 includes a base 11 and two binder layers 12 attached on two opposite surfaces thereof. The binder layers 12 are configured for conglutinating the FCCLs 20 to the reinforcing sheet 10. The base 11 is comprised of materials having high mechanical strength, heat-resistant ability, dimension and chemical stability, such as polyimide (PI), polyethylene terephtalate (PET), Teflon, or others. A thickness of the base 11 is in a range from 8 to 100 micrometers, a thickness of the binder layer 12 is in a range from 8 to 50 micrometers, and an adhesion force between the binder layer 12 and the base 11 is in a range from 0.8 to 8 gf/cm (gram force per centimeter). As such, after finishing fabricating an FPCB substrate on each binder layer 12 in the following steps, the FPCB substrates can be easily stripped from the binder layers 12 without damaging the FPCB substrates and the reinforcing sheet 10. Each FCCL 20 includes an insulating layer 21 and a copper layer 22 disposed on a surface thereof, and has a first surface 211 and an opposite second surface 221. The first surface 211 is a surface of the insulating layer 21 and the second surface 221 is a surface of the copper layer 221. The copper layer 22 is used for forming electrical traces in the following steps.

Alternatively, the reinforcing sheet 10 and the two FCCLs 20 can be provided in integral form. The reinforcing sheet 10 may include only one binder layer 12, or a multilayer structure comprised of alternately arranged bases 11 and binder layers 12 in a manner so that at least one external layer thereof is one of the binder layers 12. The reinforcing sheet 10 can further include two protecting layers respectively disposed on it's external surfaces to prevent contaminants being attached thereto. The FCCLs 20 each have two copper layers 22 disposed on two opposite surfaces of the insulating layer 21 or a multilayer structure comprised of alternately arranged insulating layers 21 and copper layers 22 in a manner so that at least one external layer is one of the copper layers 22.

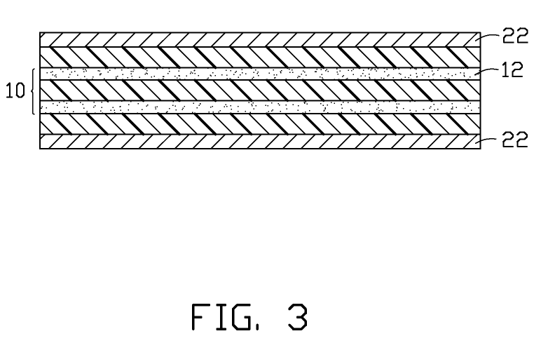

Referring to FIGS. 1 and 3, in step S3, the FCCLs 20 are attached onto each binder layer 12 of the reinforcing sheet 10 with the copper layer 22 exposed, using a typical laminating process, such as vacuum laminating. Furthermore, when the reinforcing sheet 10 includes protecting layers, prior to laminating the reinforcing sheet 10 and the FCCLs 20, the protecting layers should be removed.

As shown in FIG. 1, in step S4, electrical traces are formed in the copper layer. In detail, referring to FIG. 3, a photoresist layer 40 is applied onto the second surface 221 of each FCCL 20. The photoresist layers 40 can be comprised of positive photoresist or negative photoresist. In this embodiment, the photoresist layers 40 are made of positive photoresist.

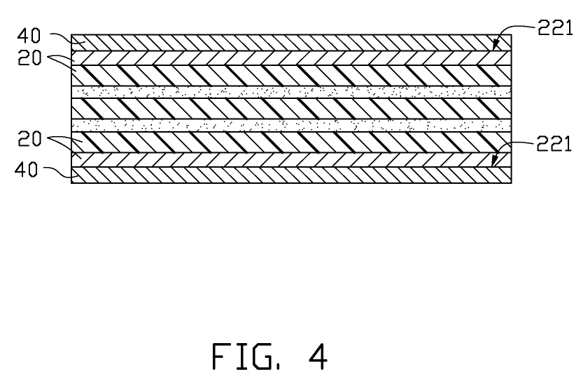

Referring to FIG. 4, the photoresist layers 40 are exposed using a photomask 41 having a plurality of predetermined patterns 411. After exposure, portions 40b of the photoresist layers 40 corresponding to the patterns 411 are polymerized while the residual portions 40a remain unpolymerized.

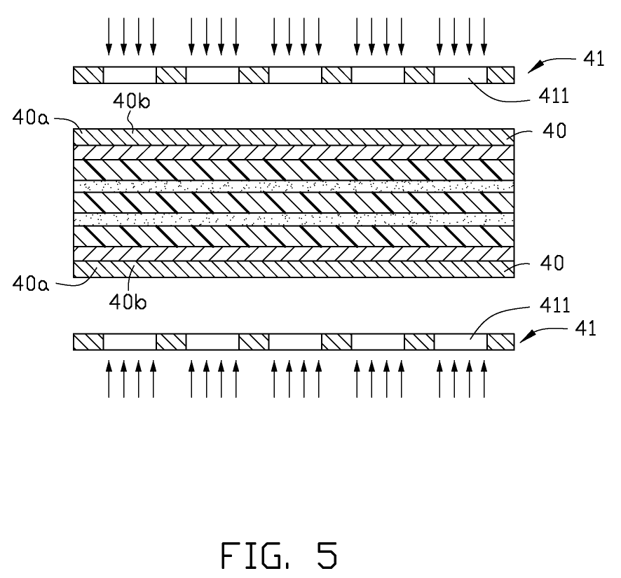

Referring to FIGS. 4 and 5, the residual portions 40a are dissolved with a known developing agent. As a result, portions 22a of the copper layers 22 corresponding to the unpolymerized portions 40a are exposed while the residual portions 22b of the copper layers 22 are covered by the portions 40b of the photoresist layer 40.

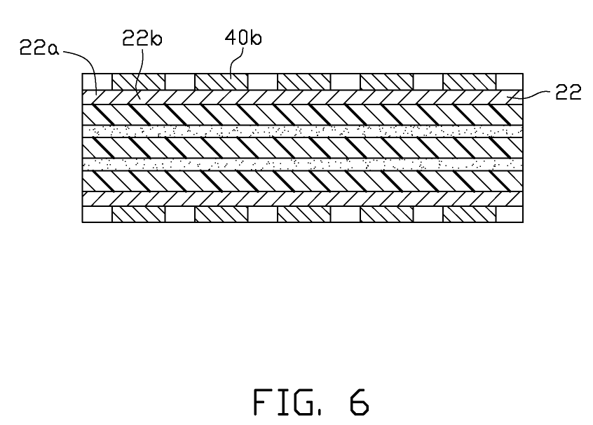

Referring to FIGS. 5 and 6, the exposed portions 22a of the copper layers 20 are removed using an etching process. After etching, electrical traces 30 remain.

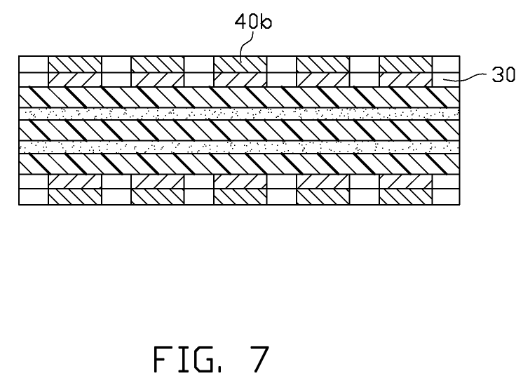

Referring to FIGS. 6 and 7, the photoresist layers 40b are removed, thus obtaining two FPCB substrates 100.

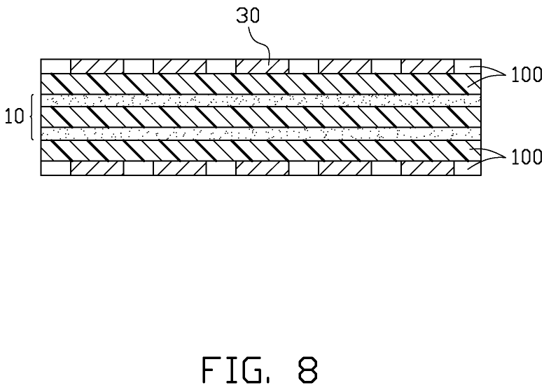

Referring to FIGS. 1 and 8, in step S5, the FPCB substrates 100 are stripped from the reinforcing sheet 10. In the illustrated embodiment, the FCCLs 20 are attached onto the reinforcing sheet 10 before applying the photoresist layer 40 onto the FCCLs 20. In such manner, the thickness of each FCCL 20 is increased, thus preventing wrinkling.

Furthermore, a number of through-holes can be formed in a predetermined region of the electrical traces 30 using a laser ablating method or a mechanical drilling process.

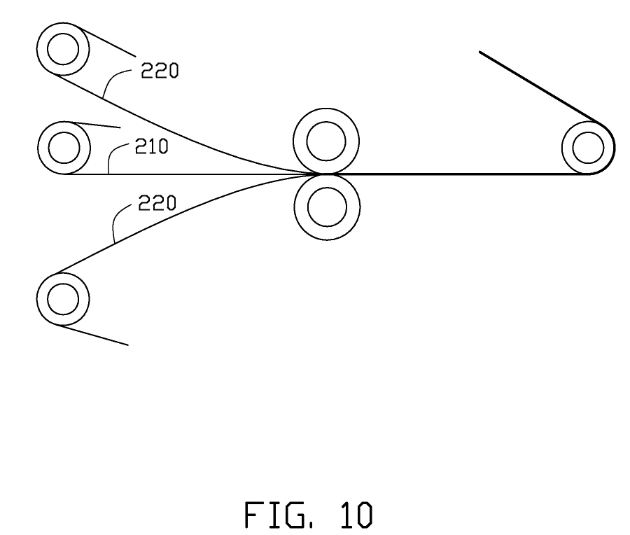

Referring to FIG. 10, another method for manufacturing an FPCB is provided in a second embodiment, differing from the first embodiment in that the two FCCLs 220 and the reinforcing sheet 210 are respectively transferred using a typical roll to roll process, and the two FCCLs 220 are attached onto the reinforcing sheet 210 using a roll press method, if need for productive efficiency.

While certain embodiments have been described and exemplified above, various other embodiments will be apparent to those skilled in the art from the foregoing disclosure. The present disclosure is not limited to the particular embodiments described and exemplified but is capable of considerable variation and modification without departure from the scope of the appended claims.

What is claimed is:

1. A method for manufacturing a flexible printed circuit board (FPCB), the method comprising:
providing a flexible copper clad laminate (FCCL), the FCCL comprising an insulating layer and a copper layer disposed thereon;
providing a rigid reinforcing sheet, the rigid reinforcing sheet comprising a base and a binder layer attached thereon;
attaching the FCCL onto the binder layer of the rigid reinforcing sheet in a manner that the insulating layer of the FCCL is adhered to the binder layer of the rigid reinforcing sheet, and the copper layer is exposed, an adhesion force between the binder layer and the FCCL being in a range from 0.8 to 8 gf/cm;
forming electrical traces in the copper layer, thus obtaining an FPCB attached on the rigid reinforcing sheet; and
removing the rigid reinforcing sheet from the FPCB.

2. The method as claimed in claim 1, wherein the FCCL is attached on the binder layer using a vacuum laminating process.

3. The method as claimed in claim 1, wherein the reinforcing sheet comprises a protecting layer covering a surface of the binder layer for prevent contamination attaching on the binder layer, the method further comprising removing the protecting layer.

4. A method for manufacturing a flexible printed circuit board, comprising:
supplying an FCCL using a roll to roll process, the FCCL comprising an insulating layer and a copper layer disposed thereon;
supplying a rigid reinforcing sheet using a roll to roll process, the rigid reinforcing sheet comprising a base and a binder layer attached thereon;
laminating the FCCL onto the rigid reinforcing sheet, using a roll press process, such that the insulating layer of the FCCL is attached onto the binder layer of the rigid reinforcing sheet and the copper layer is exposed, an adhesion force between the binder layer and the FCCL is in a range from 0.8 to 8 gf/cm;
forming electrical traces in the copper layer, thus obtaining an FPCB formed on the rigid reinforcing sheet; and
removing rigid the reinforcing sheet from the FPCB.
